(19) United States
(12) Patent Application Publication
(10) Pub. No.: US 2009/0091618 A1
(43) Pub. Date: Apr. 9, 2009

(54) ELECTRONIC VIEWER FOR PEEPHOLE

(76) Inventor: LEROY E. ANDERSON, BOISE, ID (US)

Correspondence Address: DYKAS, SHAVER & NIPPER, LLP, P.O. BOX 877, BOISE, ID, 83701-0877, US

(21) Appl. No.: 12/245,996

(22) Filed: Oct. 6, 2008

Related U.S. Application Data
(60) Provisional application No. 60/977,790, filed on Oct. 5, 2007.

(51) Int. Cl. H04N 7/18; H04N 5/232

(52) U.S. Cl. 348/143; 348/347; 348/E07.085; 348/E05.042

(57) ABSTRACT

The invention is an electronic viewer for placement in a door so that a person inside a residence may view, on an electronic screen, a person who is outside the door. The unit includes a zoom function which zooms to the lower center, to the right, left, lower left, or lower right of the screen in order to give the user inside the door a better view of a person or persons outside the door.

### CROSS-REFERENCE TO RELATED APPLICATIONS

This application claims the priority date of the provisional application entitled ELECTRONIC VIEWER filed by Leroy E. Anderson on Oct. 5, 2007 with application Ser. No. 60/977,790.

### FIELD OF THE INVENTION

The invention generally relates to an apparatus for viewing through a door and more particularly to a digital device for viewing from one side of a door to another.

### BACKGROUND OF THE INVENTION

It is a common technology from a door such as a residential door to be drilled so that an optical viewer may be installed in the door. A person typically would view from the inside of a house, out the optical viewer, to see who is on the outside of the door. A fish eye or wide angel lens might be used on the outside of the door to provide a better field of view for the viewer. Due to the widespread installation of optical viewers in a door penetrating tube with an eye piece on the inside, many residential homes have a hole already drilled in them for installation of this kind of apparatus.

An electronic viewer which may be installed in place of the optical viewer has certain advantages. This application is directed at an electronic version of a peephole viewer, with features which are not possible in the optical version of a peephole viewer.

### SUMMARY OF THE INVENTION

The invention is an electronic peephole viewer which includes a digital camera lens, a digital viewing screen, a zoom feature, a zoom activation button. The digital camera lens is configured for mounting into a position adjacent to a region to be viewed, with the region to be viewed located at some distance remote from the user of the electronic viewer. In this embodiment of the invention, the digital camera lens would be mounted in the hole formed in the door for installation of a peephole device. The region to be viewed would be directly outside the door. The digital viewing screen is configured for mounting on the inside of the door, a short distance from the digital camera lens and is electrically connected to the digital camera lens either by wireless or by wired connection. The digital viewing screen is positioned, whether in a pre-existing hole or by one drilled for this purpose, in a convenient position for the user of the electronic viewer to view an image on the digital viewing screen of what is outside the door.

The digital view screen includes a zoom feature that selects a region in the displayed image for magnification with that region being a region other than the center of the image. The typical zoom lens zooms towards the center of the image and makes the center of an image larger. The zoom feature of this viewer zooms to a region that is not the center of the picture, and that, in one version, can be selectable by the user. For instance, the viewer may be configured to zoom to the lower center of the image. This kind of a zoom would be useful if the person outside the door is standing to the left or right of the center of the door, or if they are crouched lower than the typical field of view of a door viewer. Zooming to the center bottom of the image, in such a case, would allow the user behind the door to get a better image of a short person, or a person crouching below the field of view of the viewer, or a person standing to the left or right of the center of the screen.

A zoom activation button is included that can take a number of different forms which will be discussed below. An image which is viewed in the digital viewing screen is magnified when the zoom activation button is activated and the image is magnified to show greater detail in that part of the image which is selected.

A preferred version of the device is configured specifically to zoom in on the lower center of the displayed image. The zoom feature can be based on optics in the digital camera lens and also can be based on software enhancement of the image by digital manipulation. The zoom feature can also be specifically configured to zoom in on the lower right region of the image, or the lower left region of the image. The device can also be configured with the capacity to zoom in on more than one region of the image, with the selection of the region for zooming in being left to the user's control. In such a case, a zone selection button would be provided, which would allow the region of the image selected for magnification to be identified by the user. The zone selection button can be in the form of a touch screen button, such as allowing the user to merely touch the lower center, lower right, lower left, upper center, upper right, upper left at his discretion, with the resulting magnification of that region of the image. The zone selection button can also take the form of a button which is activated repeatedly, and the selection area cycled through the different options of regions for magnification until the user selects which view he would like to have magnified.

The electronic viewer can also have a magnification button, with which the user selects from a number of different levels of magnification. The electronic viewer can also have a brightness button to allow the user to adjust the brightness of the image to a preferred level of brightness.

For night or better vision, LED lights can be added and directed to various areas that you want lit up to appear on your monitor.

A version of the electronic device can be configured for mounting on one side of a door, such as a door to a residence with the digital viewer being portable. The digital camera lens would be placed on the outside of the door, and the digital viewing screen could be placed in a convenient location inside the residence. This could be on the inside of the door, to act as a digital peephole, or could also be as a portable unit so that the home owner could carry it with him and position it in various places. By this means, the homeowner could see who was outside the front door at any time he chose, from any place in the residence, such as from sitting in another room, or from the garage or basement.

The electronic viewer can be used in multiples, such as with a number of digital camera lenses placed at various locations around a house, with all of them viewable on one or more digital viewing screen(s). A camera selection button would be provided in this instance to provide a way for the user to select the image and camera that are displayed on the monitor. This version of the electronic viewer would have a selection means to select a region on each image of each camera for viewing and magnification of the selected region. A magnification selection means would be provided for different levels of magnification for any of the images for any of the cameras of this version of the device. When used in security applications, a motion detector could be used to turn the camera(s) on, or a switch on the monitor or a combination of both. A memory program may be added to the cameras so an individual may come later and play back what the camera has seen, with magnification available for the views recorded. A speaker and a microphone can be added to the camera unit so a person can carry on a conversation between the monitor and the camera unit so that somebody in the house can control a gate like a sentry unit. The camera could be used with a motion sensor so motion would also activate an alarm in the home and the monitor.

The electronic viewer of the invention can be configured to operate with battery power or ac power, with rechargeable batteries, DC, or any combination of those electrical sources.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective exploded view of the door viewer of the invention.

FIG. 2 is a perspective view showing the camera side of the viewer.

FIG. 3 is a perspective view of the viewer with the display unit visible.

FIG. 4 is a front view of the viewer with an image on the screen.

FIG. 5 is a front view of the viewer zoomed in on an image in lower center.

FIG. 6 is a cross-sectional side view of the viewer mounted in a door.

FIG. 7 is a front view of the back side of the viewer.

FIG. 8 is a diagram showing the logic of activating and using the zoom feature of the viewer.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

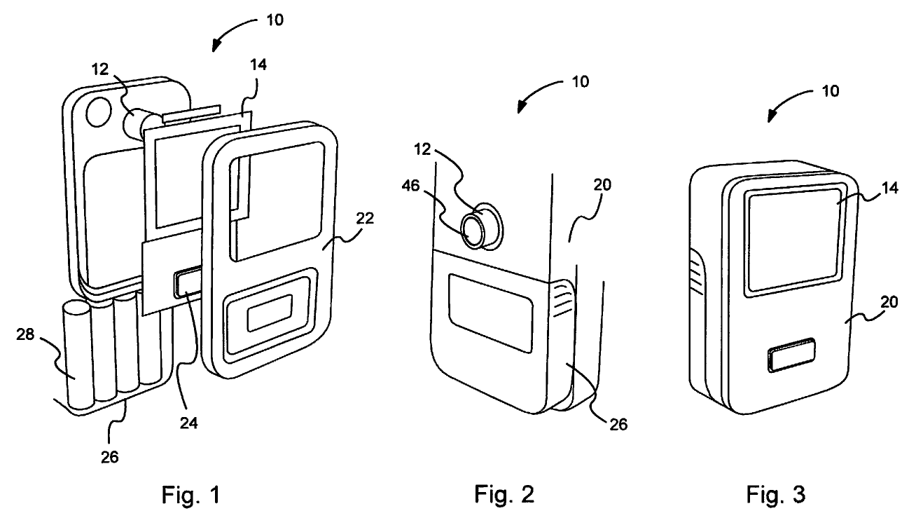

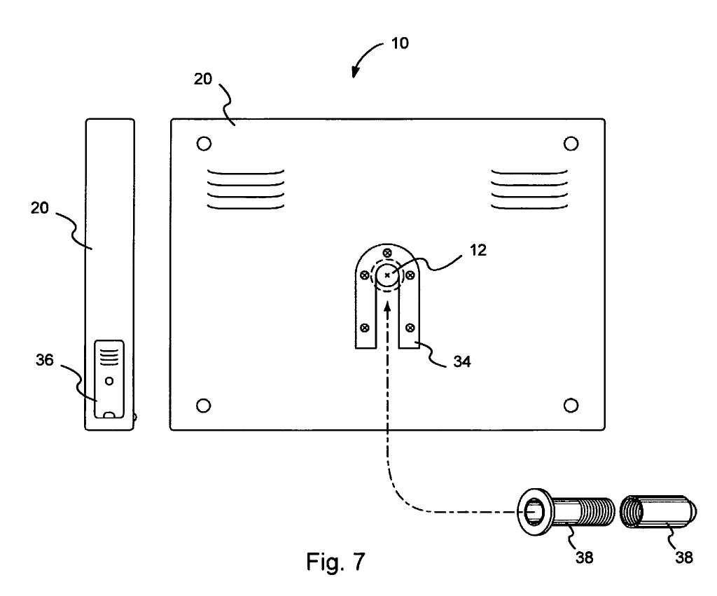

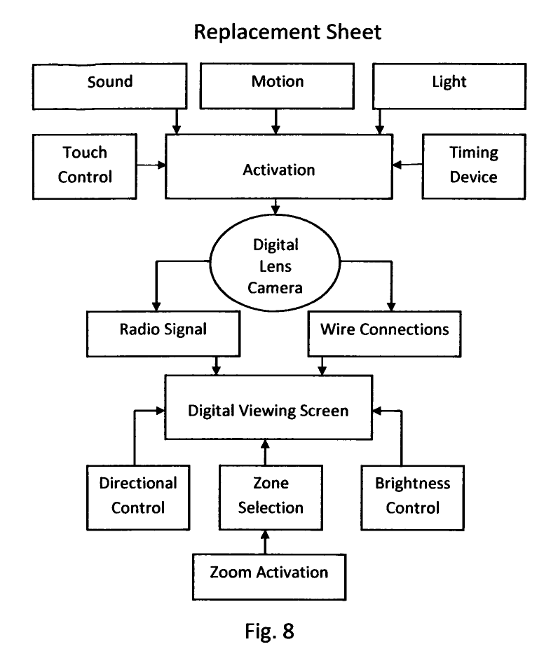

The electronic viewer of the invention is shown in FIGS. 1-9. FIG. 1 shows an exploded view of the electronic viewer of the invention. Shown is the digital viewing screen 14, the digital camera lens 12, the display cover 22, the battery box 26, and batteries 28.

The electronic viewer 10 of the invention further includes a speaker/microphone 46 which is shown in FIG. 2.

FIG. 3 is a perspective view of the electronic viewer 10 of the invention in which the pieces are assembled and the view screen 14 is visible.

FIG. 6 shows a cross-sectional view of the electronic viewer 10 of the invention mounted in a door 32. The door 32 would either be drilled to have a hole through the door, or an existing peephole viewer would be removed from the door, leaving a hole for installation of the electronic viewer 10 of the invention. FIG. 6 shows the electronic viewer 10 of the invention with the digital viewing screen 14 mounted on one side of the door and the digital camera lens 12, mounted on the other side of the door. In the example shown in FIG. 6, the camera and the view screen are connected by wiring and may be placed inside a door tube 30 as part of the installation kit. The device can also be installed on a door in which there is no pre-existing peephole viewer hole, and the digital camera lens 12 is mounted on one side of the door, and is in communication with the viewing screen 14 using any one of a number of available wireless technologies.

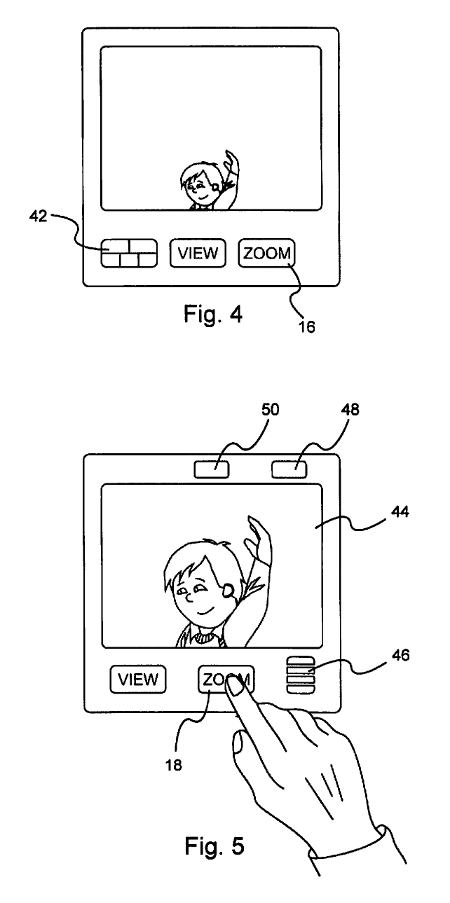

The electronic viewer 10 of the invention also has the capability of zooming in on an object with a zoom feature which zooms to an off-center region of the screen. It is common in the prior art for an electronic viewing device to zoom straight forward and to magnify the portion of the screen which is in the center of the screen. This is generally a workable practice in Items such as cameras. However, in a viewer which is utilized in a door situation, it is more advantageous to zoom to an area that is not in the center of the view screen. This requires the use of a zoom point selection pad which can be in the form of a pad of buttons shown in FIG. 4, or can be in the form of a touch screen zoom selection such as shown in FIG. 44. By choosing the area to zoom towards, the view screen zooms, for instance, to the lower bottom of the screen, the lower left or right, the right side of the screen, the left side of the screen, or the center left or right upper part of the screen.

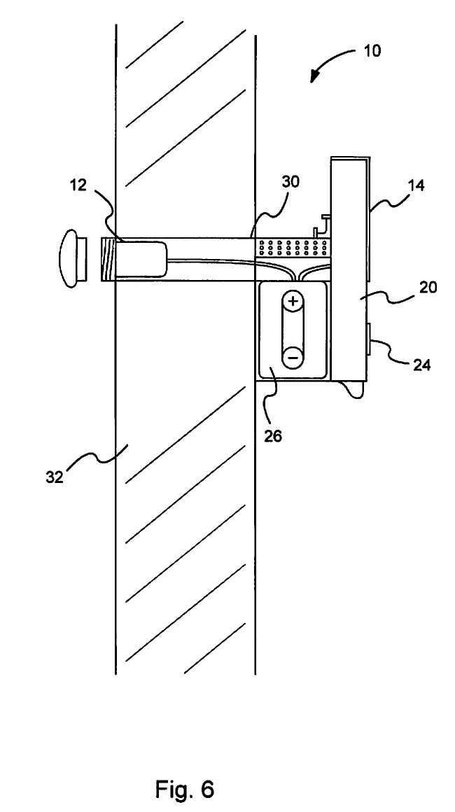

FIG. 4 shows an image of a person in the lower center of the view screen 14. When a selection is made on the zoom point selection pad 42 to zoom to the lower center of the screen, the view changes to that shown in FIG. 5. Shown in FIG. 4 is a view button 24 which activates the unit and a zoom button 16 which controls the amount of magnification of the image.

FIG. 5 also shows a magnification button 50, and a brightness button 48. The brightness button 48 can be tapped to brighten the image on the viewscreen.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An electronic viewer, comprising:
a digital camera lens for mounting in a position adjacent to a region to be viewed, with said region to be viewed remote from a user of said electronic viewer;
a digital viewing screen for mounting in a position at a selected distance from said digital camera lens, for convenient viewing of said region to be viewed by said user;
a zoom feature in which a selected region is magnified, in which the region magnified is a region other than the center of the image of said region to be viewed;
a zoom activation button; wherein
an image viewed in the digital viewing screen is magnified when said zoom activation button, and said image is magnified to show greater detail of a part of the image which is not the center of the image.

2. The electronic viewer of claim 1 in which said zoom feature is configured to magnify a region of said image located in the lower center of said image.

3. The electronic viewer of claim 1 in which said zoom feature is based on software magnification of said image.

4. The electronic viewer of claim 1 in which said zoom feature is configured to magnify a region of said image located in the lower right of said image.

5. The electronic viewer of claim 1 in which said zoom feature is configured to magnify a region of said image located in the lower left of said image.

6. The electronic viewer of claim 1 in which said zoom feature is configured to magnify one of a plurality of regions of said image, in which the region to be magnified is not the center of the image.

7. The electronic viewer of claim 6 in which said electronic viewer further comprises a zone selection button, for selecting a region of said image to magnify.

8. The electronic viewer of claim 6 in which said electronic viewer further comprises a zone selection button in the form of a touch screen, for selecting a region of said image to magnify.

9. The electronic viewer of claim 1 in which digital camera lens' said zoom feature is configured to magnify one of a plurality of regions of said image, in which the region to be magnified is not the center of the image.

10. The electronic viewer of claim 7 which further comprises a magnification button to change magnification to different levels of magnification.

11. The electronic viewer of claim 7 which further comprises a brightness button to change brightness of said image to different levels of brightness.

12. The electronic viewer of claim 2 in which said digital camera lens is configured for mounting on the rear of an automobile, for viewing a region around a centrally located towing ball mounted on said automobile, with said zoom function configured to magnify an image of said towing ball in the lower center of said image.

13. The electronic viewer of claim 2 in which said digital camera lens is configured for mounting on one side of a door, with said digital viewing screen configured for placement on an opposite side of said door.

14. The electronic viewer of claim 2 which further includes a voice transmittal feature.

15. The electronic viewer of claim 2 in which said digital camera lens is configured for mounting in a stand for placement above printed material, to serve as a reading aid

16. The electronic viewer of claim 15 which further includes a light source for illuminating said printed material.

17. The electronic viewer of claim 2 in which said digital viewing screen is configured to be portable from said digital camera lens, for placement in any location chosen by a user.

18. The electronic viewer of claim 2 which further includes a plurality of cameras placed at various locations around a vehicle, with a monitor with a camera selection button or means to select which camera to display an image from on said monitor.

19. The electronic viewer of claim 17 which further comprises a selection means to select a region on each image of each camera for viewing, and a magnification means for magnification of the selected region of the selected image.

20. The electronic viewer of claim 18 which further comprises a magnification selection means for selecting different levels of magnification for the image selected from the various cameras.

21. The electronic viewer of claim 18, which further includes an alarm configured to sound when an object is within a specified distance of the viewer.
